(19) United States
(12) Patent Application Publication
(10) Pub. No.: US 2010/0110222 A1
(43) Pub. Date: May 6, 2010

(54) DIGITAL CAMERA FRONT-END ARCHITECTURE

(75) Inventors: David E. Smith, Allen, TX (US); Deependra Talla, Dallas, TX (US); Clay Dunsmore, Garland, TX (US); Ching-Yu Hung, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/689,071

(22) Filed: Jan. 18, 2010

Related U.S. Application Data
(62) Division of application No. 11/219,925, filed on Sep. 6, 2005.
(60) Provisional application No. 60/606,944, filed on Sep. 3, 2004.
(60) Provisional application No. 60/607,380, filed on Sep. 3, 2004.

(51) Int. Cl. H04N 5/228

(52) U.S. Cl. 348/222.1; 348/E05.031

(57) ABSTRACT

A video processing front-end for digital cameras, camcorders, video cell phones, et cetera has multiple interconnected processing modules for functions such as CCD controller, preview engine, auto exposure, auto focus, auto white balance, et cetera with complicated data flow can be realized and managed.

### CROSS-REFERENCE TO RELATED APPLICATIONS

This application is a divisional of non-provisional application Ser. No. 11/219,925 filed Sep. 6, 2005, which claims priority from provisional application Nos. 60/606,944 and 60/607,380, both filed Sep. 3, 2004, which are all herein incorporated by reference.

### BACKGROUND

The present invention relates to digital video signal processing, and more particularly to architectures and methods for digital camera front-ends.

Imaging and video capabilities have become the trend in consumer electronics. Digital cameras, digital camcorders, and video cellular phones are common, and many other new gadgets are evolving in the market. Advances in large resolution CCD/CMOS sensors coupled with the availability of low-power digital signal processors (DSPs) has led to the development of digital cameras with both high resolution image and short audio/visual clip capabilities. The high resolution (e.g., sensor with a 2560×1920 pixel array) provides quality offered by traditional film cameras.

FIG. 2a is a typical functional block diagram for digital camera control and image processing (the “image pipeline”). The automatic focus, automatic exposure, and automatic white balancing are referred to as the 3A functions; and the image processing includes functions such as color filter array (CFA) interpolation, gamma correction, white balancing, color space conversion, and JPEG/MPEG compression/decompression (JPEG for single images and MPEG for video clips). Note that the typical color CCD consists of a rectangular array of photosites (pixels) with each photosite covered by a filter (the CFA): typically, red, green, or blue. In the commonly-used Bayer pattern CFA one-half of the photosites are green, one-quarter are red, and one-quarter are blue.

Typical digital cameras provide a capture mode with full resolution image or audio/visual clip processing plus compression and storage, a preview mode with lower resolution processing for immediate display, and a playback mode for displaying stored images or audio/visual clips.

A digital signal processing device that provides the imaging and video computation and data flow faces multiple challenges:
High data rate.
Heavy computation load
Many variations of data flow. Often an image or a video frame is processed multiple times due to data dependency, and usually on-chip memory is not large enough to hold each frame, so there are multiple passes to an external memory (usually SDRAM). Traffic among frames often overlap (or pipelined) to reduce the perceived processing time.
   Thus there is a problem of providing an efficient architecture for a camera video processing front-end.

### SUMMARY OF THE INVENTION

The present invention provides a digital camera video processing front-end architecture of multi-interconnected autonomous processing modules for efficient operation.

### BRIEF DESCRIPTION OF THE DRAWINGS

FIGS. 1a-1d illustrate functional blocks of a preferred embodiment front-end, a buffer interface, a video processing subsystem, and a digital camera processor.

FIGS. 2a-2b are functional block diagrams for a generic digital camera image pipeline and a generic network connection.

FIG. 3 shows functional blocks of a preferred embodiment CCD/CMOS controller.

FIGS. 4a-4c illustrates data flow and reformatter in a preferred embodiment CCD/CMOS controller.

FIG. 5 shows timing.

FIG. 6 illustrates the preview engine.

FIG. 7shows a horizontal median filter.

FIG. 8 shows a noise filter.

FIG. 9 shows white balance.

FIG. 10 shows CFA interpolation.

FIG. 11 shows black adjustment.

FIG. 12 shows color blending

FIG. 13 shows color conversion.

FIG. 14 shows luminance enhancer.

FIG. 15 shows a resizer module.

FIG. 16 illustrates resizer flow.

FIGS. 17a-17b show resampling.

FIGS. 18a-18b show resampling.

FIG. 19 illustrates highpass gain for edge enhancement.

FIG. 20 shows h3A functional blocks.

FIG. 21 illustrates preprocessing for 3A functions.

FIG. 22 shows a horizontal median filter.

FIG. 23 illustrate pixel extraction examples.

FIG. 24 shows an IIR filter.

FIG. 25 shows paxel configuration.

FIG. 26 illustrates windows for auto exposure/auto white balance.

FIG. 27 is a vertical focus block diagram.

FIG. 28 is a vertical focus functional block diagram.

FIG. 29 shows a histogram block diagram.

FIG. 30 shows an example of region organization and priority.

### DESCRIPTION OF THE PREFERRED EMBODIMENTS

### 1. Overview

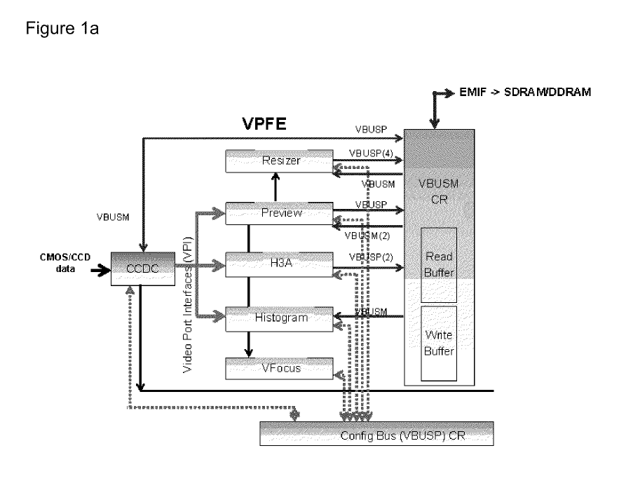

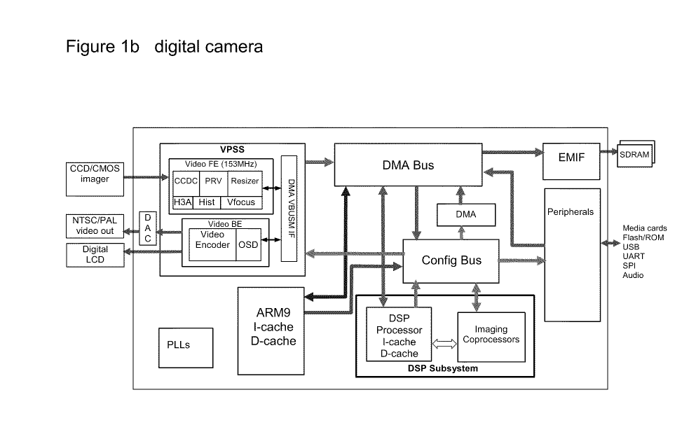

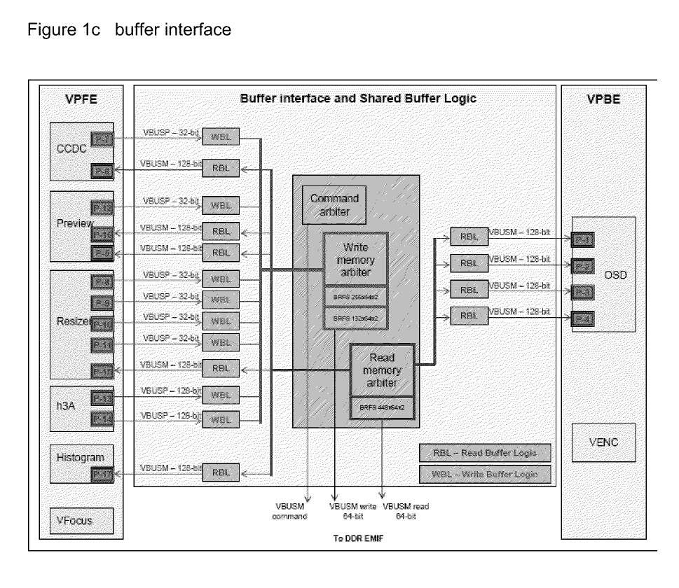

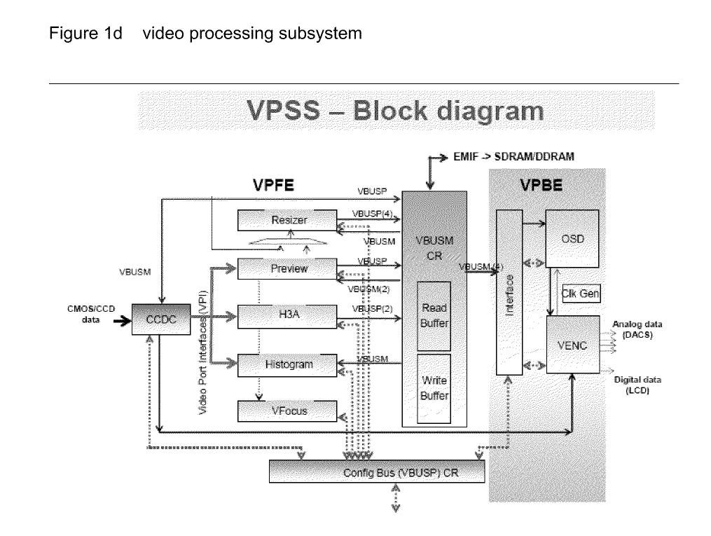

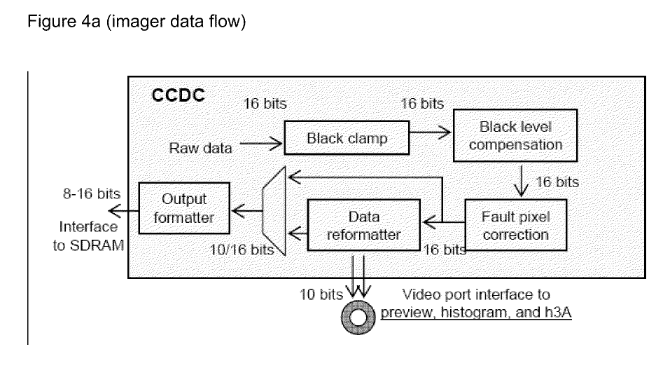

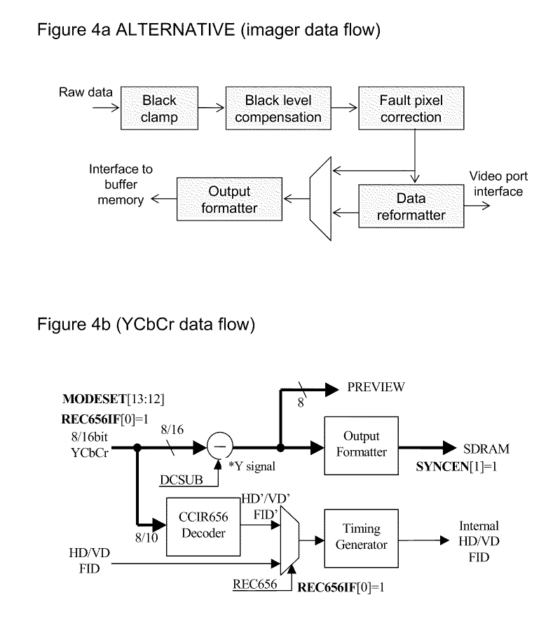

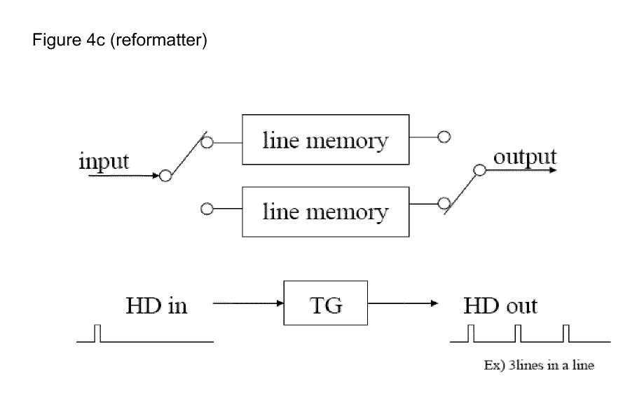

Preferred embodiment video processing front-end (VPFE) architectures include multiple processing modules (e.g., CCD controller, preview engine, 3A functions, histogram, resizer) interfaced together in such a way that complicated data flow can be realized and managed. FIG. 1a is a block diagram for a first preferred embodiment VPFE which contains the following processing modules:
The CCDC (CCD/CMOS controller) receives input from CCD/CMOS image sensor, formats the data properly for processing, and deals with active region framing and black level subtraction.
The Preview engine processes sensor data through white balancing, noise filtering, CFA interpolation, color blending, gamma correction, and color space transform steps.
The h3A module handles AE/AWB (auto exposure, auto white balancing), statistics calculations, and horizontal AF (auto focus) metrics computations.
The VFocus module handles vertical AF (auto focus) computations.
The Histogram module collects additional statistics information over specified regions of an image, so that a processor can adapt AE/AWB parameters according to the scene and lighting conditions.
The Resizer module performs image resampling to upsample or downsample images/video frames for various resolution requirements.
   These modules are discussed in more detail in the following sections. The processing modules are tied together with one-to-one connections to allow the modules to be connected to a processing chain or network. Maximal chaining can provide the following processing:
(a) CCDC-->Preview-->Resizer and, in parallel, Preview-->VFocus
(b) CCDC-->H3A
(c) CCDC-->Histogram
   See the Video Port Interface (VPI) in FIG. 1a and description of the CCDC in section 3 and FIG. 4a.

The FIG. 1a processing modules are also tied to a bus central resource (CR) with read/write buffers and bus arbiters to allow efficient use of external memory bandwidth though the external memory interface (EMIF); FIG. 1c shows more details as described in section 2 below.

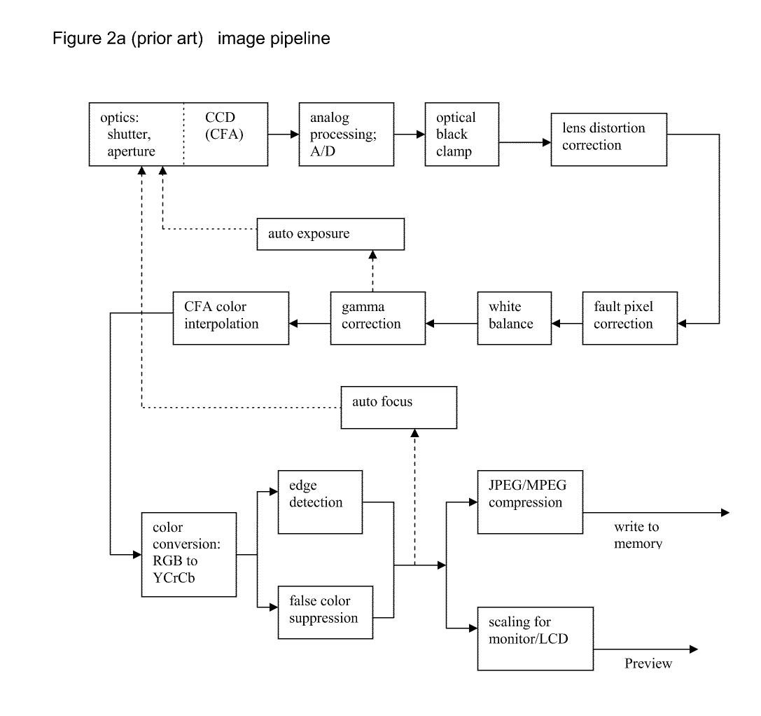

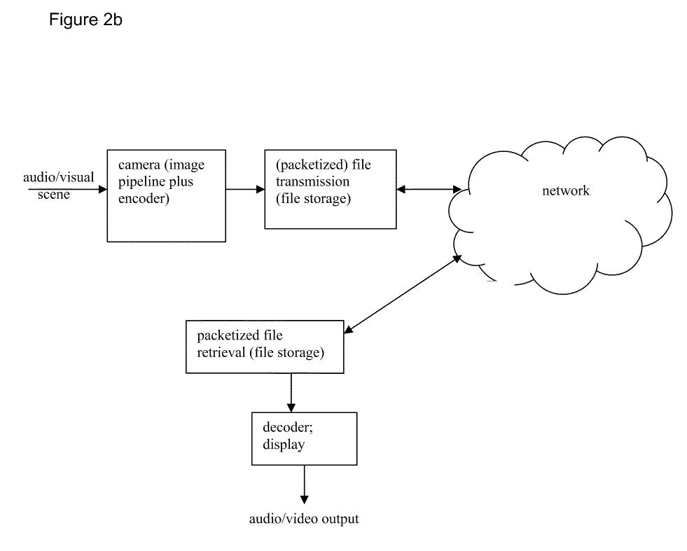

FIG. 1a also shows the processing modules tied to a configuration/MMR (memory-mapped registers) bus central resource; the configuration bus can connect the processing modules to a program controller (e.g., ARM RISC processor in FIG. 1b) which can control parameters, such as using the h3A and VFocus output to control the optics for the CCD as indicated in FIG. 2a.

FIG. 1b shows an integrated circuit processor for a digital camera which includes a preferred embodiment VPFE (upper left in FIG. 1b) plus other processors such as a program controller (ARM), programmable processors for image pipeline computations like CFA interpolation (DSP and IMX-VLC/VLD), external memory manager, and a video processing back-end (VPBE) which contains modules such as onscreen display (OSD) and video encoder for output to display devices (VENC). Note that the VPFE alone (i.e., the DSP and IMX only used from some post processing) can be used for still image capture, and the VPFE can capture large images even with a limited width processing setup by partitioning a large image into multiple panels for processing and stitching the processed panels together. For example, with a 1280-pixel width, two panels would typically handle a 5 megapixel image.

FIG. 1c (and section 2 below) shows more detail of the connections of the VPFE processing modules with the external memory read/write buffers together with bus priorities plus port bit widths. Note that a processing module reads from the external memory through the read buffer on a bus with VBUSM protocol; whereas, a processing module writes to the external memory through the write buffer on a bus with VBUSP protocol. Essentially, the VBUSM protocol provides non-blocking split-transaction on reads, whereas the VBUSP protocol provides single-transaction posted writes. That is, reads should be split into request and read-data transactions, so a pending read does not block subsequent read requests. Writes should be implemented as posted writes, so a pending write is buffered, while subsequent writes can still be accepted.

FIG. 1d shows the VPFE together with a video processing back-end (VPBE) which shares the read buffers and bus for reads from the external memory. Note that the CCDC can send data directly to the video encoder (VENC) for output with minimal processing.

The control mechanism for each module is autonomous to allow chain-regulated as well as concurrent dataflow. For example, we can have data transfers such as:
(a) Image sensor-->CCDC-->VBUSM CR-->EMIF-->SDRAM
(b) SDRAM-->EMIF-->VBUSM CR-->Preview-->Resizer--> -->VBUSM CR-->EMIF-->SDRAM
(c) SDRAM-->EMIF-->VBUSM CR-->Histogram
   all at the same time.

The ability to chain processing steps and to allow multiple concurrent autonomous threads of computation adds significant flexibility and power efficiency to digital processing devices that incorporate the VPFE architecture.

The inter-module video port interface (VPI) is a bus that carries video data as well as video clock, data enable, horizontal synchronization (HSYNC) and vertical synchronization signals. With synchronization information incorporated into the interface, modules can be connected in different configurations easily in alternative chip designs.

The video port interface is also used inside the CCD Controller and the Preview engine modules to connect processing stages. This allows a modular design methodology that enables reconfiguration of the processing stages in CCDC or Preview, and allows reuse of these processing stages in other modules.

CCD Controller's video signal output is transmitted over two instances of the video port interface (VPI in FIG. 1a), to represent two simultaneous lines of image/video. The downstream modules (Preview, Histogram, and H3A) each receives either both or just one video port, depending on its processing dependency. Preview and Histogram each receives one port; H3A receives both ports.

Preferred embodiment systems (digital still cameras, digital camcorders, video cell phones, netcams, et cetera) include preferred embodiment VPFE with any of several types of additional hardware: digital signal processors (DSPs), general purpose programmable processors, application specific circuits, or systems on a chip (SoC) such as multicore processor arrays or combinations of a DSP and a RISC processor together with various specialized programmable accelerators; see FIG. 1b. A stored program in an onboard or external (flash EEP)ROM or FRAM could implement the signal processing. Analog-to-digital converters and digital-to-analog converters can provide coupling to the analog world; modulators and demodulators (plus antennas for air interfaces) can provide coupling for transmission waveforms; and packetizers can provide formats for transmission over networks such as the Internet as illustrated in FIG. 2b.

### 2. Shared Buffer Logic/Memory

The shared buffer logic/memory is a unique block that is tailored for seamlessly integrating the VPSS into an image/video processing system. It acts as the primary source or sink to all the VPFE and VPBE modules that are either requesting or transferring data from/to the SDRAM/DDRAM. In order to efficiently utilize the external SDRAM/DDRAM bandwidth, the shared buffer logic/memory interfaces with the direct memory access (DMA) system via a high bandwidth bus (64-bit wide). The shared buffer logic/memory also interfaces with all the VPFE and VPBE modules via a 128-bit wide bus. The shared buffer logic/memory (divided into the read and write buffers plus arbitration logic) is capable of performing the following functions.
(a) Make appropriate VBUSM requests to the DMA interface to either transfer or request data to/from the SDRAM/DDRAM. The data (input or output) resides in the (read or write) buffer memory.
(b) Interface to the preview engine module.
   Collect output data from the preview engine in the write buffer (1 32-bit VBUSP port)
   Transfer input data and dark frame subtract data to the preview engine from the read buffer (2 128-bit VBUSM ports)
(c) Interface to the CCDC module.
   Collect output data from the CCDC in the write buffer (1 32-bit VBUSP port)
   Transfer fault pixel table data to the CCDC from the read buffer (1 128-bit VBUSM port)
(d) Interface to the h3A module.
   Collect output data from the h3A in the write buffer (2 128-bit VBUSP ports—one each for AF and AE/AWB)
(e) Interface to the histogram module.
   Transfer input data to the histogram from the read buffer (1 128-bit VBUSM port)
(f) Interface to the resizer module.
   Collect output data from the resizer in the write buffer (4 32-bit VBUSP ports)
   Transfer input data to the resizer from the read buffer (1 128-bit VBUSM port)
(g) Interface to the OSD module.
   Transfer input data to the OSD from the read buffer (4 128-bit VBUSM ports)

The shared buffer logic is capable of arbitrating between all the VPFE and VPBE modules and the DMA SCR0 based on fixed priorities. It is designed to maximize the SDRAM/DDRAM bandwidth even though each of the individual VPFE/VPBE modules makes data transfers/requests in smaller sizes. Based on the bandwidth analysis, the arbitration scheme for the buffer memory between all the VPFE modules, VPBE, and the DMA SCR0 (DDR EMIF) interface needs to be customized for each system. It is important to note that the VPSS requests to the DMA SCR0 interface should be treated as the highest priority on the system to guarantee correct functionality. It is possible to lower the priority of the VPSS requests to the DDR EMIF by a register setting. FIG. 1c shows the block diagram of the shared buffer logic/memory and its interaction with the VPFE and VPBE processing modules.

The shared buffer logic/memory comprises the following to achieve its functionality:
(a) A read buffer memory (instantiated as a 448×64×2 BRFS memory) that is responsible for satisfying read requests from the various modules with the source being the SDRAM/DDRAM. Each request going out to the DDR EMIF is up to a transfer of 256 bytes.
   Each module owns a certain number of bytes in the read buffer memory (statically assigned on 256 byte boundaries; 256 bytes denotes a data-unit) depending on the read throughput requirement. The modules with lower bandwidth/throughput requirements are assigned only 2 data-units per read port while the modules with higher bandwidth/throughput requirements are assigned with 4 data-units per read port.
   CCDC gets 2 data-units (512 bytes or 32×64×2) for reading in the fault pixel correction table entries.
   Preview engine gets 4 data-units (1024 bytes or 64×64×2) for reading in the input data and another 4 data-units (1024 bytes or 64×64×2) for reading in the dark frame subtract data.
   Resizer gets 4 data-units (1024 bytes or 64×64×2) for reading in the input data.
   Histogram gets 2 data-units (512 bytes or 32×64×2) for reading in the input data.
   OSD gets 4 data-units (1024 bytes or 64×64×2) for video window0, 4 more data-units (1024 bytes or 64×64×2) for video window1, 2 more data-units (512 bytes or 32×64×2) for graphics/overlay window0, and 2 additional data-units (512 bytes or 32×64×2) for graphics/overlay window1.
   There may be optimizations to provide additional data-units for any module if another module is disabled (its data-units are unused). Implementing this optimization would allow for a more latency tolerant VPSS (global request priority can be lowered with more confidence).
(b) Two write buffer memories (instantiated as 256×64×2 and 192×64×2 BRFS memory) that are responsible for satisfying the write requests from the various modules with the sink being the SDRAM/DDRAM. Each request going out to the DDR EMIF is up to a transfer of 256 bytes.
   Each module owns a certain number of bytes in the write buffer memory (statically assigned on 256 byte boundaries; 256 bytes denotes a data-unit) depending on the write throughput requirement. The modules with lower bandwidth/throughput requirements are assigned only 2 data-units per write port while the modules with higher bandwidth/throughput requirements are assigned with 4 data-units per write port.
   The 256×64×2 write buffer memory (#0) is dedicated to the resizer module. Resizer gets 4 data-units (1024 bytes or 64×64×2) for writing out line1, 4 more data-units (1024 bytes or 64×64×2) for writing out line2, 4 more data-units (1024 bytes or 64×64×2) for writing out line3, and 4 additional data-units (1024 bytes or 64×64×2) for writing out line4.
   The 192×64×2 write buffer memory (#1) is dedicated to the CCDC, preview engine, and the h3A module.
   CCDC gets 4 data-units (1024 bytes or 64×64×2) for writing out the output data.
   Preview engine gets 4 data-units (1024 bytes or 64×64×2) for writing out the output data.
   h3A gets 2 data-units (512 bytes or 32×64×2) for writing out AF data and an additional 2 dataunits (512 bytes or 32×64×2) for writing out AE/AWB data.
   There may be optimizations to provide additional data-units for any module if another module is disabled (its data-units are unused). Implementing this optimization would allow for a more latency tolerant VPSS (global request priority can be lowered with more confidence).
(c) Multiple write buffer logic (WBL) blocks to interface between the respective module/write port and the write buffer memory (resizer WBLs write to write buffer memory #0 while the CCDC/preview engine/h3A WBLs write to write buffer memory #1).
   One WBL per one write port (total of 8 WBLs).
   Each WBL is responsible for tracking all the corresponding data-units in the write buffer memory (either 2 or 4 data-units for each WBL in this instantiation).
   Each WBL is responsible for collecting the output data (32-bit or 128-bit) from the write port of the corresponding module.
   Each WBL has buffer registers inside prior to transferring to the write buffer memory.
      A 32-bit WBL has a 32-bit register (input side) followed by a 128-bit register for stacking the 32-bit values, and a 128-bit register interfacing to the write buffer memory (output side).
      A 128-bit WBL has a 128-bit register (input side) followed by a 128-bit register interfacing to the write buffer memory (output side).
   Each WBL is responsible for transferring the output data to the write buffer memory via a 128-bit wide bus (this time arbitrating with the other WBLs to get access to the write buffer memory and also the VBUSM dma interface to the DDR EMIF). The arbitration is explained in more detail when discussing the command arbiter below.
   Each module writing to the WBL will have to propagate the end of line and frame signals to the corresponding WBL.
   Each WBL is responsible for generating a VBUSM dma command to the DDR EMIF rather than the individual module itself. A VBUSM dma command can be issued in three scenarios:
      The write data has crossed a data-unit boundary of 256 bytes upon which the next write from the module goes to a different data-unit while the recently filled data-unit is to be transferred to the SDRAM/DDRAM after issuing a VBUSM dma command.
      An end of frame has occurred upon which the data-unit (even if it is not filled up fully) is to be transferred to the SDRAM/DDRAM after issuing a VBUSM dma command.
      An end of line has occurred and the start of the next line has crossed the data-unit (not within the same 256 byte boundary) upon which the data-unit is to be transferred to the SDRAM/DDRAM after issuing a VBUSM dma command.
(c) Multiple read buffer logic (RBL) blocks to interface between the respective module/read port and the read buffer memory.
   One RBL per one read port (total of 9 RBLs).
   Each RBL is responsible for tracking all the corresponding data-units in the read buffer memory (either 2 or 4 data-units for each RBL in this instantiation).
   Each RBL is responsible for sending the input data (128-bit) to the read port of the corresponding module.
   Each RBL has two buffer registers inside prior to transferring to the corresponding module/read port.
      RBL has a 128-bit register followed by a 128-bit register.
   Each RBL is responsible for accepting the input data from the read buffer memory via a 128-bit wide bus (this time arbitrating with the other RBLs to get access to the read buffer memory and also the VBUSM dma interface to the DDR EMIF). The arbitration is explained in more detail when discussing the command arbiter below.
   Unlike the WBL, the RBL is not responsible for issuing the VBUSM dma commands to the DDR EMIF; each individual module is responsible for doing this.
(d) A command arbiter to arbitrate between the various VBUSM commands that are generated by the modules (reads) and the WBLs (writes).
   Fixed priority arbitration among a total of 17 different masters (as shown in FIG. 1c).
      P1—OSD video window0 input (read) data
      P2—OSD video window1 input (read) data
      P3—OSD graphic/overlay window0 input (read) data
      P4—OSD graphic/overlay window1 input (read) data
      P5—preview engine dark frame subtract input (read) data
      P6—CCDC fault pixel table input (read) data
      P7—CCDC output (write) data
      P8—resizer output line 1 (write) data
      P9—resizer output line 2 (write) data
      P10—resizer output line 3 (write) data
      P11—resizer output line 4 (write) data
         The four resizer ports have another level of arbitration between themselves. If resizer output line 1 is the last of the four resizer ports to be written out, then resizer output line 2 wins the next arbitration among the four ports. Similarly, line 3 wins if previous line was 2, line 4 wins if previous line was 3, and line 1 wins if previous line was 4. Note that this applies when the corresponding output line is active (no wasted time slot in the arbitration).
      P12—preview engine output (write) data
      P13—h3A (AF) output (write) data
      P14—h3A (AE/AWB) output (write) data
      P15—resizer input (read) data
      P16—preview engine input (read) data
      P17—histogram input (read) data
   Only a total of 8 VBUSM commands can be active at any given instant of time. Once a new slot opens, the highest priority transfer gets in the command queue. While VBUSM can support up to 16 outstanding commands from a single master, the DDR EMIF can only contain up to 7 commands. Therefore the number of outstanding commands has been reduced (from 16 originally).
   When a VBUSM command is active, the read/write buffer memory is arbitrated between the various RBLs/WBLs with the VBUSM command. The VBUSM access will be required to either accept or provide 64-bits of data for every dma clock cycle. Since the VBUSM data width to the DDR EMIF is 64-bit and the read/write buffer memory width is 128-bits, it is guaranteed that the RBLs/WBLs will get access to the read/write buffer memories at least once every other cycle (dma clock).
   Arbitration between the various RBLs to the read buffer memory follows the fixed arbitration scheme between the 9 possible masters (same ordering as the VBUSM commands above).
   Arbitration between the various four resizer WBLs to the write buffer memory #0 follows the fixed arbitration scheme between the four WBL ports and the VBUSM command (lowest priority).
   Arbitration between the CCDC, preview, h3A, and the VBUSM command follow a fixed priority in that order.

There are several registers available for debugging the transfer of data between the VPSS modules and the SDRAM/DDRAM. The debug registers are divided into two categories:

(a) 8 global request registers to capture information about any of the 56 individual module request registers (each register provides information about one data-unit) at a given time. The number 8 corresponds to the maximum number of EMIF command queue entries plus one.

Each of the global request registers provides the following information:
Valid
Source/destination module
Direction (read/write)
Source/Destination ID

(b) 56 individual module request registers (either read or write information;

each register corresponds to one data-unit)
CCDC output: 4 write module request registers
CCDC fault pixel correction input: 2 read module request registers
Preview engine input: 4 read module request registers
Preview engine output: 4 write module request registers
Preview engine dark frame subtract input: 4 read module request registers
Resizer input: 4 read module request registers
Resizer output line 1: 4 write module request registers
Resizer output line 2: 4 write module request registers
Resizer output line 3: 4 write module request registers
Resizer output line 4: 4 write module request registers
Histogram input: 2 read module request registers
h3A output (AF): 2 write module request registers
h3A output (AE/AWB): 2 write module request registers
OSD video window 0: 4 read module request registers
OSD video window 1: 4 read module request registers
OSD overlay/graphic window 0: 2 read module request registers
OSD overlay/graphic window 1: 2 read module request registers
   Each of the write module request registers provides the following information:
Current byte count—number of bytes in the block of data for this command, up to 256 bytes
Data ready—block of data confirmed by the module
Data sent—data sent to the destination and waiting for status
Upper 20-bits of the address
   Each of the read module request registers provides the following information:
Valid—read requested from the module
Waiting for data—command accepted from the source
Data available—data received from the source and can be read by the module
Byte count requested—up to 256 bytes
Upper 20-bits of the address

The VPSS has a single central resource (is a BCG SCR 1-to-n generator) that generates all the individual MMR/config bus signals to the various VPFE/VPBE modules. The MMR/config bus port for each module is used to program the individual registers. The central resource itself has an input MMR/config bus port on the VPSS boundary.

Module Starting addresses could be:

| | |
|---|---|
| CCDC | 0x00000400 |
| Preview engine | 0x00000800 |
| Resizer | 0x00000C00 |
| Histogram | 0x00001000 |
| h3A | 0x00001400 |
| VFocus | 0x00001800 |
| VPBE | 0x00002400 |
| VPSS/SBL regs | 0x00003400 |

There are various embedded memories in the processing modules and the read/write buffers for external memory, as follows:

| memory name | data source | data destination | memory size |
|---|---|---|---|
| ccdc_reformatter | CCDC | preview, h3a, and | 1376 × 40 |
| | | histogram | |
| osd_clut | config bus | OSD | 256 × 24 |
| osd_resize | OSD | OSD | 368 × 16 |
| prv_nf_line_buf | preview | preview | 1312 × 40 |
| prv_nf_weights | config bus | preview | 256 × 8 |
| prv_cfa_line_buf | preview | preview | 1312 × 40 |
| prv_gamma | config bus | preview | 1024 × 8 |
| prv_nl_lum | config bus | preview | 128 × 20 |
| prv_cfa_mem | config bus | preview | 24 × 192 |
| h3a_accum | h3A | h3A | 160 × 64 |
| hist_data | histogram | histogram, config bus | 1024 × 20 |
| resize_line_buf | resizer | resizer | 640 × 48 |
| vfocus_mem | VFocus, | VFocus, | 22 × 120 |
| | config bus | config bus | |
| vpss_read_buf | DMA SCR0 | CCDC, OSD, resizer | 448 × 64 |
| | | preview, and | |
| | | histogram | |
| vpss_write_buf0 | resizer | DMA SCR0 | 256 × 64 |
| vpss_write_buf1 | CCDC, h3A, | DMA SCR0 | 192 × 64 |
| | and preview | | |

Note the abbreviations such as “clut” for coefficient lookup table; “nf” for noise filter; and “nl_lum” for non-linear luminance.

### 3. CCD/CMOS Controller

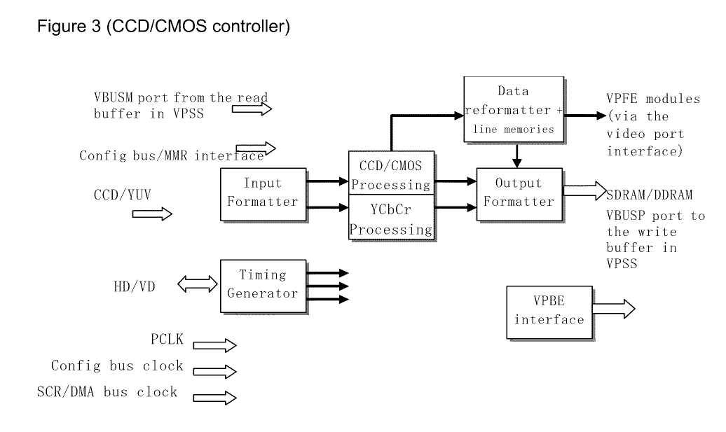

FIG. 3 is a high level block diagram of the CCD/CMOS controller (CCDC). The CCDC accepts raw image/video data from an external CCD/CMOS sensor and performs minimal image processing before it outputs the data to SDRAM/DDRAM and to the video processing front end modules. Optionally, the CCDC can accept REC656/CCIR-656 input data and output it to the SDRAM/DDRAM and/or the VPBE interface. In FIG. 3 PCLK is the pixel clock; HD/VD are the horizontal and vertical sync signals (either external or generated within the CCDC) indicating end of row and end of picture; and YUV is used instead of YCbCr.

The main processing done by the CCDC module on the raw data (from the CCD/CMOS sensor) is optical black clamping followed by a fault pixel correction; see upper portion of FIG. 4a. Following the fault pixel correction, the data can either be routed into the SDRAM/DDRAM or to the other VPFE modules (via the video port interface). In the case of the sink being the SDRAM/DDRAM, the data is packed appropriately (and culled). Prior to routing to the other VPFE modules, the CCDC data passes through a data reformatter that transforms various movie-mode readout patterns into the conventional Bayer pattern. The output of the data reformatter can also be fed to the SDRAM/DDRAM; see FIG. 4a.

The data reformatter converts nonstandard imager data format to the standard raster-scan format for processing. The imager data format, particularly in video mode (lower resolution but high frame rate, usually 30 frames/sec), varies among imager vendors and is still evolving. A programmable data reformatter architecture (see cross-referenced application Ser. No. 10/888,701, hereby incorporated by reference) comprehends many data formats today, and should support many more future data formats.

FIG. 4b shows the processing flow for YCbCr data. Control registers provide format information so that the video signal can be properly recognized and processed.

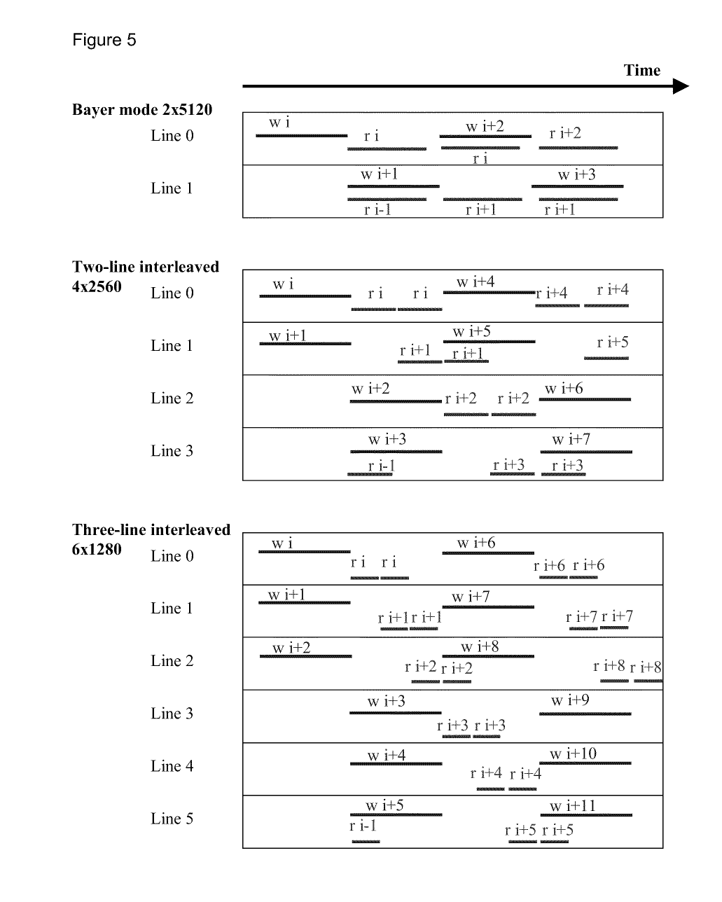

The data reformatter memory is efficiently utilized by functionally reorganizing the memory into:
5120×2 words for Bayer pattern sensor data that does not need reformatting
2560×4 words for 2-line interleaved sensor data
1280×6 words for 3-line interleaved sensor data
   The data reformatter does more than just reformat the data. The video port interface to the H3A module contains two lines of output, so that the h3A can accumulate statistics according to the Bayer pattern phases more efficiently. Even when the sensor data is already in raster scan format, the sensor data is written into the reformatter memory, then read back out together with the previous line for h3A module. FIG. 5 shows the read/write patterns for various sensor formats with wi the ith write and ri the ith read.

The fault pixel table must contain entries in ascending order (pixel read-out order) in terms of the line and pixel count. In case of interlaced sensors, the programmer can program multiple tables (one for each field of the frame), and switch the starting address in the SDRAM when the corresponding field is clocked in to the CCDC. Note that the number of fault pixels should also be modified appropriately. The fault pixel correction can be applied to movie mode sensors also (note that each fault pixel position is determined by the pixel's offset from the VD/VSYNC and HD/HSYNC).

The CCDC requests the fault pixel entries from the read buffer interface in the VPSS. The read buffer is capable of buffering up to a total of N (for example, 128 for discussion here) fault entries internally. The 128 entries (can be a variable parameter for a different chip/design) are arranged as two 64 entry blocks in a ping-pong scheme. On every new frame, the read buffer logic issues a request to the system DMA controller to transfer 64 entries into the internal buffer. A second request is also sent immediately after that. Further requests are satisfied only upon the complete utilization of 64 entries. In order to allow time to fetch the fault pixels from the SDRAM/DDRAM, the number of fault pixels to be corrected in a certain time will be limited by the system DMA bandwidth and latency. At a minimum, the time to transfer 64 entries from the external location (typically SDRAM/DDRAM) should be less than the time to exhaust (fault-pixel correct) the 64 entries residing in the other block. If this requirement is not met at any instant of time, then the fault-pixel correction circuitry in the CCDC will flag an error bit and halt processing for that frame. There is no error recovery implemented where this circuitry can correct as many fault-pixels as possible after not being able to correct a fault-pixel due to bandwidth/latency issues.

Following the fault pixel correction, the raw data can be stored into the SDRAM/DDRAM for software image processing (e.g., the DSP and coprocessor subsystem in FIG. 1b). The output of the video port interface can also be an input to this path optionally via a register setting. The output formatter block provides options for applying an anti-aliasing filter for horizontal culling. The low-pass filter consists of a simple three-tap (¼, ½, and ¼) filter. Two pixels on the left and two pixels on the right of each line are cropped if the low-pass filter is enabled. In the data compression pass, any 10 bits of 16 bit CCD data are compressed to 8 bits via the A-law table. Then the pixels are packed and stored to SDRAM. This format can secure the less SDRAM/DDRAM capacity. The A-law table has a similar characteristic as a voice codec.

The CCDC module is capable of transforming movie mode readout patterns (such as Sony, Fuji, Sharp, Matsushita) into Bayer readout patterns. The advantage of such a conversion is that the remaining VPFE modules need not be designed to handle formats other than Bayer and Foveon patterns. This vastly simplifies the design effort in those modules. Following the fault pixel correction, the CCDC module utilizes the data reformatter memory and logic for this transformation. Data from the reformatter memory is stored as the Bayer pattern and this is in turn the input to the various VPFE modules.

The basic idea behind the data reformatter is to convert a single line of movie mode sensor into multiple Bayer lines. FIG. 4c shows the block diagram of the data reformatter. The data reformatter memory is capable of outputting 2 pixels (on 2 consecutive horizontal lines) to the various VPFE modules. Therefore, it is capable of buffering two horizontal lines. This is required by the fact that the h3A module requires two horizontal lines for performing AE/AWB calculations. The h3A module by itself does not have any line memory, but it shares the data reformatter memory. This is a good architectural tradeoff where the total memory required by the data reformatter and the h3A block is less than the sum of individual data reformatter memory size and individual h3A line memory size.

### 4. Preview Engine

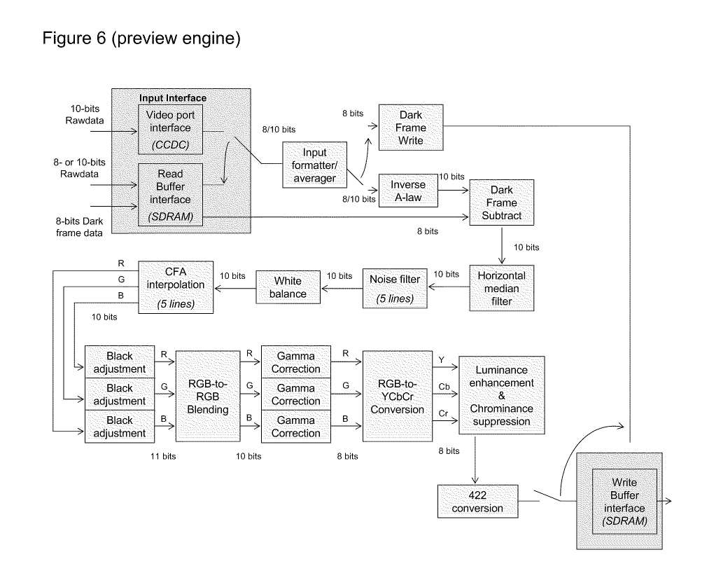

FIG. 6 shows a high level block diagram of the Preview Engine. Processing stages in the preview engine are connected in a fixed pattern, as in the diagram. Each processing stage is configurable by control registers to support various signal processing requirements. Each processing stage can also be bypassed through control register setting. The Preview Engine architecture provides a good level of flexibility and programmability while balancing the hardware cost.

The preview engine receives raw image/video data from either the video port interface via the CCDC block (which is interfaced to the external CCD/CMOS sensor) or from the read buffer interface via the SDRAM/DDRAM. The input data is 10-bits wide if the source is the video port interface. When the input source is the read buffer interface, the data can either be 8-bit or 10-bits. The 8-bit data can either be linear or non-linear. In addition, the preview engine can optionally fetch a dark frame from the SDRAM/DDRAM with each pixel being 8-bits wide.

The starting input SDRAM/DDRAM address should be on a 32-byte boundary. Even though, the address is programmed as 32-bits, the 5 LSB are treated as zeroes. The 16-bit line offset register also must be programmed on a 32-byte boundary. Similar to the starting address, the 5 LSB are treated as zeroes for the 16-bit offset register. Furthermore, the dark frame subtract input and the preview engine output addresses and line offsets must be on a 32-byte boundary.

When the input source is the SDRAM/DDRAM, the preview engine always operates in the one-shot mode; the enable bit is turned off and it is up to the firmware to re-enable it to process the next frame from the SDRAM/DDRAM.

The preview engine can only output 1280 pixels in each horizontal line due to the line memory width restrictions in the noise filter and CFA interpolation blocks. In order to support sensors that output greater than 1280 pixels per line, an averager is incorporated to downsample by factors of 1 (no averaging), 2, 4, or 8 in the horizontal direction. The horizontal distance between two consecutive pixels to be averaged is selectable between 1, 2, 3, or 4. Furthermore, the horizontal distance between two consecutive pixels for even and odd lines can be programmed separately. The valid output of the input formatter/averager is either 8- or 10-bits wide. Alternatively, a wide image could be partitioned into panels of at most 1280 pixels, each panel processed without averaging, and the processed panels stitched together.

The preview engine is capable of writing a dark frame to the SDRAM-/DDRAM instead of performing the conventional processing steps. This dark frame can later be used for subtracting from the raw image data. Each input pixel is written out as an 8-bit value; if the input pixel value is greater than 255, it is saturated to 255. The idea here is that if a dark pixel is greater than 255, it is more likely to be a fault pixel and can be corrected by the fault pixel correction module in the CCDC.

In order to save capacity and bandwidth when the input source to the preview engine is the SDRAM/DDRAM, data could be stored in an A-law compressed (non-linear) space by the CCDC. The inverse A-law block decompresses the 8-bit non-linear data to 10-bit linear data if enabled. If the A-law block is not enabled, but the input is still 8-bits, the data is left shifted by 2 to make it 10-bit data. If the input is 10-bits wide in the first place, no operation is performed on the data.

The preview engine is capable of optionally fetching a dark frame containing 8-bit values from the SDRAM/DDRAM and subtracting it pixel-by-pixel to the incoming input frame. The output of the dark frame subtract is 10-bits wide (U10Q0). The firmware is responsible for allocating enough SDRAM/DDRAM bandwidth to the preview engine if this feature is enabled. At its peak (operating at 75 MP/s), the dark frame subtract read bandwidth is 75 MB/s.

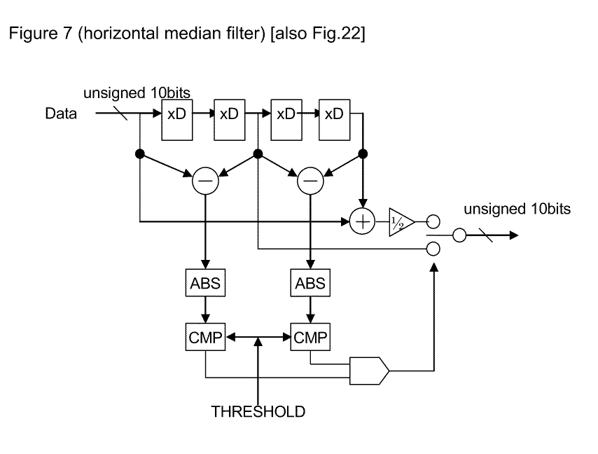

The preview engine contains a horizontal median filter that is useful for reducing temperature induced noise effects. The horizontal median filter, shown in FIG. 7, calculates the absolute difference between the current pixel (i) and pixel (i−X) and between the current pixel (i) and pixel (i+X). If the absolute difference exceeds a threshold, and the sign of the differences is the same, then the average of pixel (i−X) and pixel (i+X) replaces pixel (i). The horizontal median filter's threshold is configurable and the horizontal median filter can either be enabled or disabled. The horizontal distance (X) between two consecutive pixels can be either 1 or 2. Furthermore, the horizontal distance can be programmed separately for even and odd lines. The input and output of the horizontal median filter are 10-bits wide (U10Q0).

If the horizontal median filter is enabled, the preview engine will reduce the output of this stage by 4 pixels (2 starting pixels—left edge and 2 ending pixels—right edge) in each line. For example, if the input size is 656×490 pixels, the output will be 652×490 pixels. There will be no chopping of data if this block is disabled.

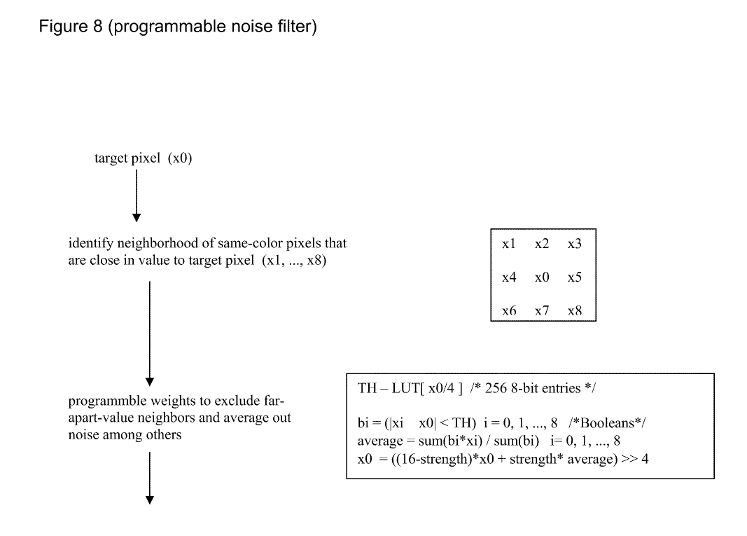

Following the horizontal median filter, a programmable filter that operates on a 3×3 grid of same color pixels reduces the noise in the image/video data. This filter always operates (identifies neighborhood same-color pixels that are close in value) on nine pixels of the same color. FIG. 8 shows the method of this filter. An 8-bit threshold is obtained on indexing the current pixel into a 256-entry table. If the absolute difference of the current pixel and each of its eight neighbors is less than the threshold, that neighboring pixel is used in computing an average as shown in FIG. 7. The average is then added to the current pixel with specified weights to generate the noise-filtered output pixel. The threshold should be set to exclude far-apart-value neighbors and average the noise among the remaining same-color pixels. Table lookup with the current pixel allows the noise level to be modeled as a function of the pixel value.

If the noise filter is enabled, the preview engine will reduce the output of this stage by 4 pixels in each line (2 starting pixels—left edge and 2 ending pixels—right edge) and 4 lines in each frame (2 starting lines—top edge and 2 ending lines—bottom edge). For example, if the input size is 656×490 pixels, the output will be 652×486 pixels. There will be no chopping of data if this block is disabled.

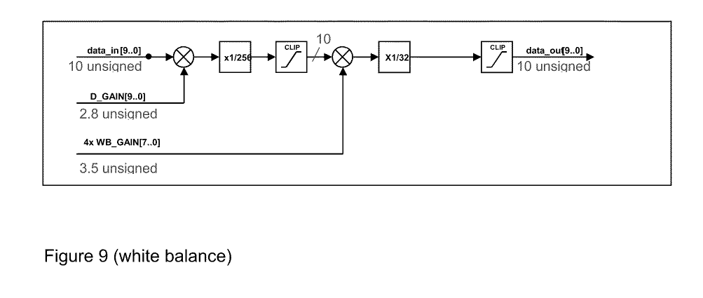

The white balance module has two gain adjusters, a digital gain adjuster and a white balance adjuster. In the digital gain adjuster, the raw data is multiplied by a fixed value gain regardless of the color of the pixel to be processed. In the white balance gain adjuster, the raw data is multiplied by a selected gain corresponding to the color of the processed pixel. The white balance gain can be selected from four 8-bit values depending on the position of the current pixel modulo 4 or 3 (selectable in control register setting). Firmware can assign any combination of up to 4 pixels in the horizontal and vertical direction (up to 16 total locations). For example, the white balance gain selected for pixel #0 and line #0 can be different than pixel #2 and line #0. FIG. 9 shows the block diagram of the white balance module.

The CFA interpolation block is responsible for populating the missing color pixels at a given location resulting in a 3-color RGB pixel. The CFA interpolation module will be bypassed in the case of the Foveon sensor since the image is fully populated with all the three primary colors. In the case of Bayer pattern, the CFA interpolation should work for either primary color sensors, complementary color sensors, or four color sensors.

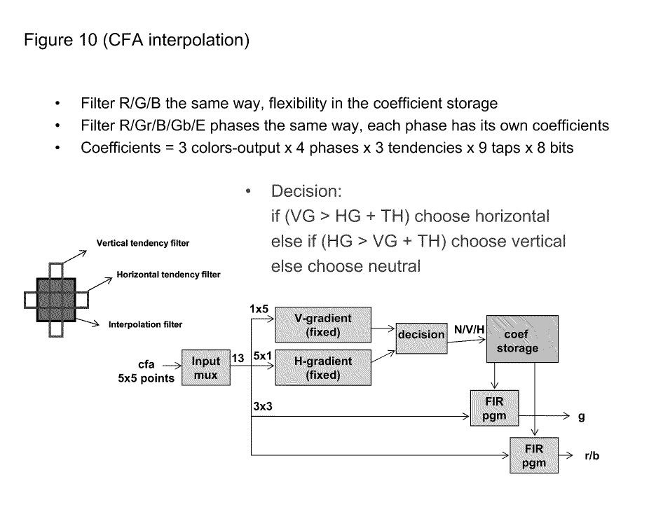

The CFA interpolation is implemented using programmable filter coefficients, with each coefficient being 8-bits wide. Each of the three output colors (R, G, and B) has their own coefficients. There are 9 coefficients per output color (to accommodate a 3×3 fully populated grid). In addition, there are 4 phases for each color representing the position in the 2×2 grid. Furthermore, different sets of filter coefficients are provided depending on the tendency (either horizontal, vertical, or neutral) as shown in FIG. 10.

The horizontal and vertical gradients are computed as:

Gradient=ABS(X₁X)/2+ABS(X₊₁X)/2+ABS(X₁X₊₁)+ABS(X₊₂X)+ABS(X₂X)

Based on the phase, color, and tendency, the 9 selected filter coefficients are used to compute the output pixel by performing 2D 3×3 FIR filtering. Since the preview engine will be able to be clocked at least twice the incoming raw input data rate, only 14 multipliers are required to implement the CFA interpolation. 9 of the 14 multipliers are used in computing either the red or blue color. The remaining 5 multipliers are used in computing the partial green. In the next cycle, 9 of the 14 are used to compute either blue or red and the other 5 multipliers are used to compute the remaining green color.

The CFA filter coefficients are stored in an internal memory inside the preview engine. Firmware is responsible for programming the table entries.

The CFA interpolation step can be optionally disabled. In this case, the input stream is duplicated into 3 streams to represent the red, green, and blue colors. If the CFA interpolation is enabled, the preview engine will reduce the output of this stage by 4 pixels in each line (2 starting pixels—left edge and 2 ending pixels—right edge) and 4 lines in each frame (2 starting lines—top edge and 2 ending lines—bottom edge). For example, if the input size is 656×490 pixels, the output will be 652×486 pixels for each of the three output colors. There will be no chopping of data if this block is disabled.

The CFA interpolation architecture provides directional information and allows the firmware to configure filter coefficients for each direction tendency. By providing orthogonally programmable coefficients, the CFA interpolation stage can deal with different sensor characteristics, different lighting/scene characteristics, and can implement special effects like sharpening and softening in conjunction for free. For example, complementary color sensor can be supported with the same architecture but with filter coefficients selected to comprehend color space transformation.

The output of the CFA interpolation is three pixels (red, blue, and green values) and this is fed as input to the black adjustment module. The black adjuster module performs the following calculation for an adjustment of each color level.

data_out=data_in+b1_offset

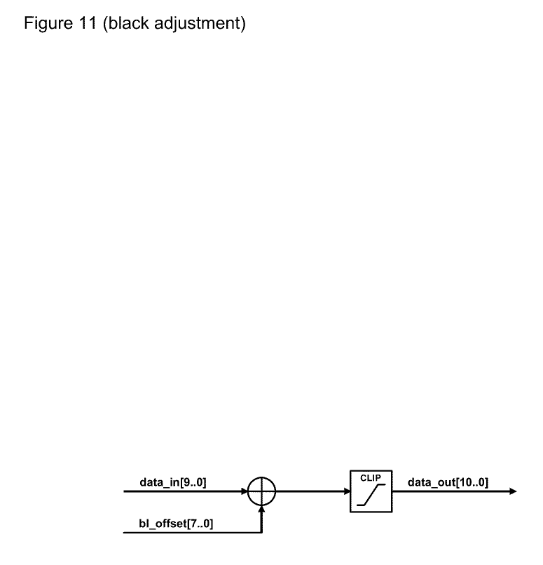

FIG. 11 shows the block diagram of this black adjuster module. A simple addition and a clip operation are processed in this module. The output data_out[10 . . . 0] is signed.

The RGB2RGB blending module has a general 3×3 square matrix and redefines the RGB data from the CFA interpolation module, which can be used as a function of a color correction. The input is signed 11-bits and the output is unsigned 10-bits. In this module, the following calculation is made.

$$[ \begin{matrix}{R}_{out} \\ {G}_{out} \\ {B}_{out}\end{matrix} ] = [ \begin{matrix}MTX\_RR & MTX\_GR & MTX\_BR \\ MTX\_RG & MTX\_GG & MTX\_BG \\ MTX\_RB & MTX\_GB & MTX\_BB\end{matrix} ] [ \begin{matrix}{R}_{i n} \\ {G}_{i n} \\ {B}_{i n}\end{matrix} ] + [ \begin{matrix}R\_offset \\ G\_offset \\ B\_offset\end{matrix} ]$$

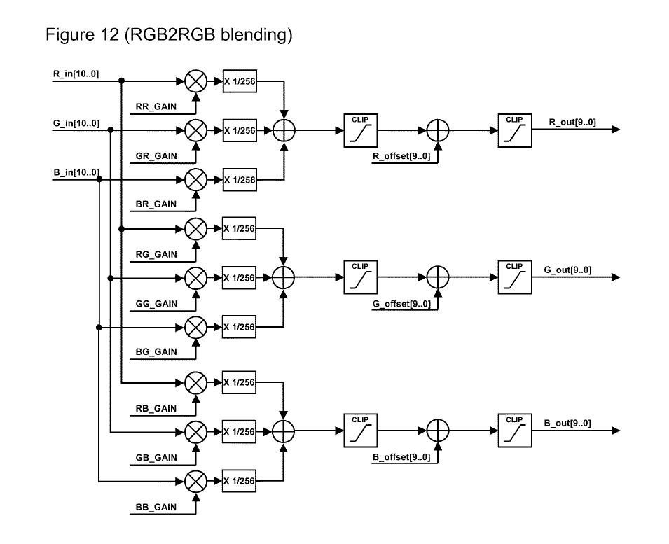

Each of the gains is 12-bit data with a range of −8 to +8 (with 8-bit fraction). FIG. 12 shows the block diagram of the RGB2RGB blending module. Nine multipliers and six adders are required for performing this matrix operation.

The gamma correction is performed on each of the R, G, and B pixels separately by using a RAM based lookup. Each table has 1024 entries and is programmed by the firmware, with each entry being 8-bit wide. The input data value is used to index into the table and the table content is the output. The host processor can only write the gamma RAM (via registers) when the preview engine is disabled.

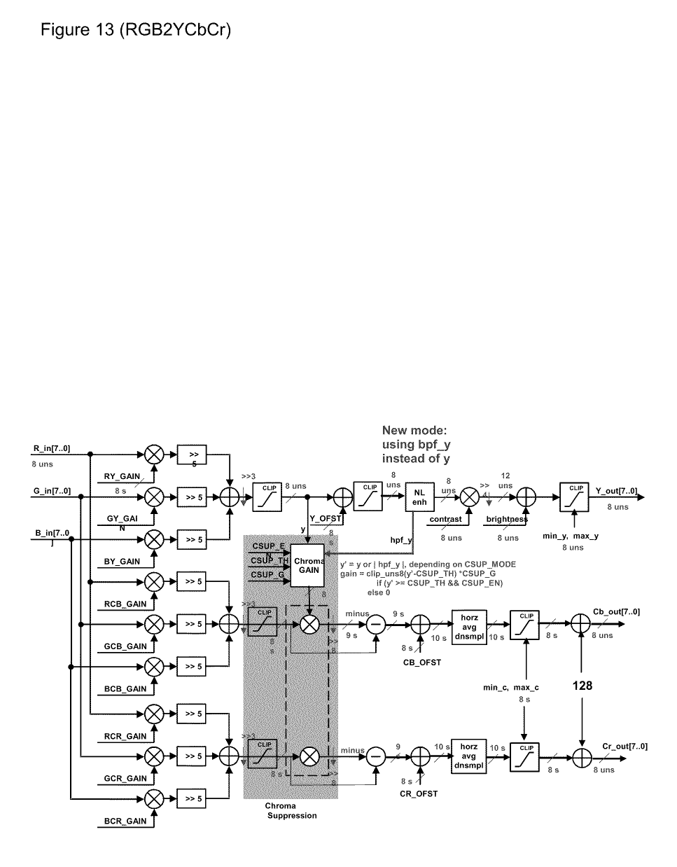

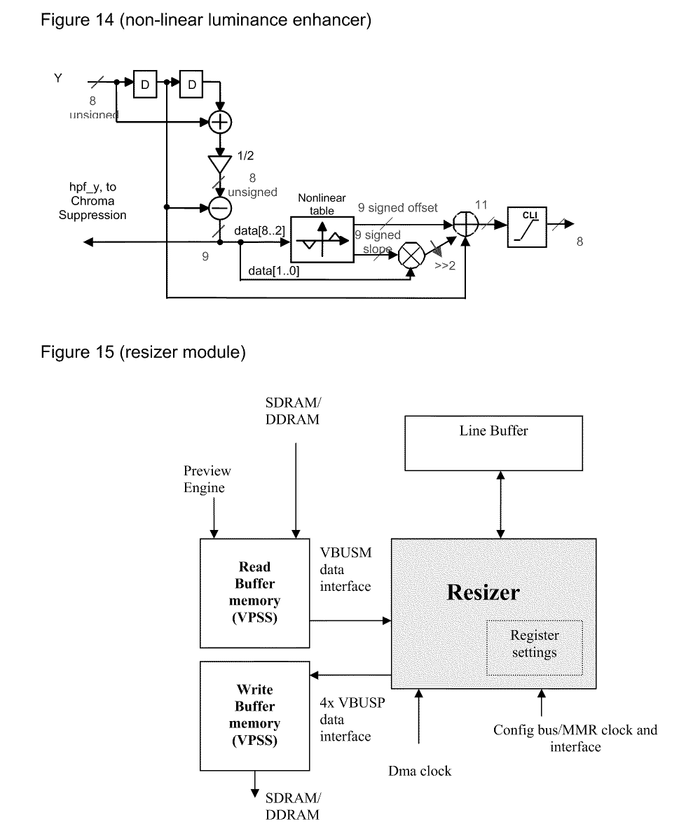

The RGB2YCbCr conversion module has a 3×3 square matrix and converts the RGB color space of the image data into the YCbCr color space. In addition to the conversion matrix operation, offset, contrast, brightness and chroma suppression are performed in this module. FIG. 13 shows the block diagram of the RGB2YCbCr conversion matrix. It is composed of nine multipliers and three adders for the basic conversion matrix, two multipliers for the chroma suppression and 2 adders for the chroma offset. In addition to the above operations, a non-linear enhancement on the luminance component (Y data) is necessary. FIG. 14 shows the operation of the non-linear enhancer. The non-linear luminance operation can be described as follows. Basically, a high-passed version of Y is computed as

hpy(i)=y(i)−(y(i−1)+y(i+1)/2;

and fed to a lookup table with interpolation (optionally, the luminance value y itself can be fed instead of the high-passed version of Y)

offset(i) = offset_lut[hpy(i) >> 2];
slope(i) = slope_lut[hpy(i) >> 2];
interpolated(i) = offset(i) + (slope(i) * (hpy(i) & 0x3))>>2;

The interpolated output is then added to original Y to complete the luminance enhancement.

enh_{—}y(i)=clip(y(i)+interpolated(i));

If the non-linear luminance enhancer is enabled, the preview engine will reduce the output of this stage by 2 pixels (1 starting pixel—left edge and 1 ending pixel—right edge) in each line. For example, if the input size is 656×490 pixels, the output will be 654×490 pixels. There will be no chopping of data if the non-linear luminance enhancer is disabled.

### 5. Resizer

The resizer module performs either upsampling (digital zoom) or downsampling on image/video data. The input source can be either the preview engine or SDRAM/DDRAM and the output is sent to the SDRAM/DDRAM. FIG. 15 shows the high level block diagram of the resizer module.

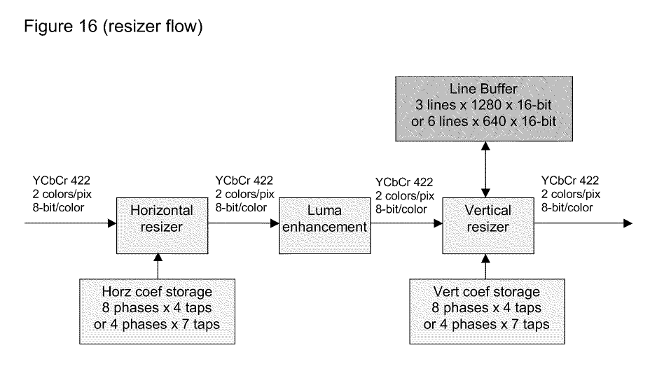

The resizer module performs horizontal resizing then vertical resizing. In between there is an optional edge enhancement feature. Processing flow and data precision at each stage are shown in FIG. 16.

The line buffer is functionally either 3 lines of 1280 pixels×16-bit or 6 lines of 640 pixels×16-bit, depending on the vertical resizing being 4-tap or 7-tap mode. In hardware implementation, the line buffer is intended to be a single block of memory organized as 640×96-bit.

The resizer module has the ability to upsample or downsample image data with independent resizing factors in the horizontal and vertical directions (HRSZ and VRSZ). The same resampling algorithm is applied in both the horizontal and vertical directions. For the rest this section, the horizontal direction is used in describing the resampling algorithm. The HRSZ and VRSZ parameters can range from 64 to 1024 to give a resampling range of 0.25× to 4× (256/RSZ). There are 32 programmable coefficients available for the horizontal direction and another 32 programmable coefficients for the vertical direction. The 32 programmable coefficients are arranged as either 4-taps & 8-phases for the resizing range of ½x−4× or 7-taps & 4-phases for a resizing range of ¼x−˜½× (upper step not included). Table 2 shows the arrangement of the 32 filter coefficients. Each tap is arranged in a S10Q8 format (signed value of 10-bits with 8 of them being the fraction).

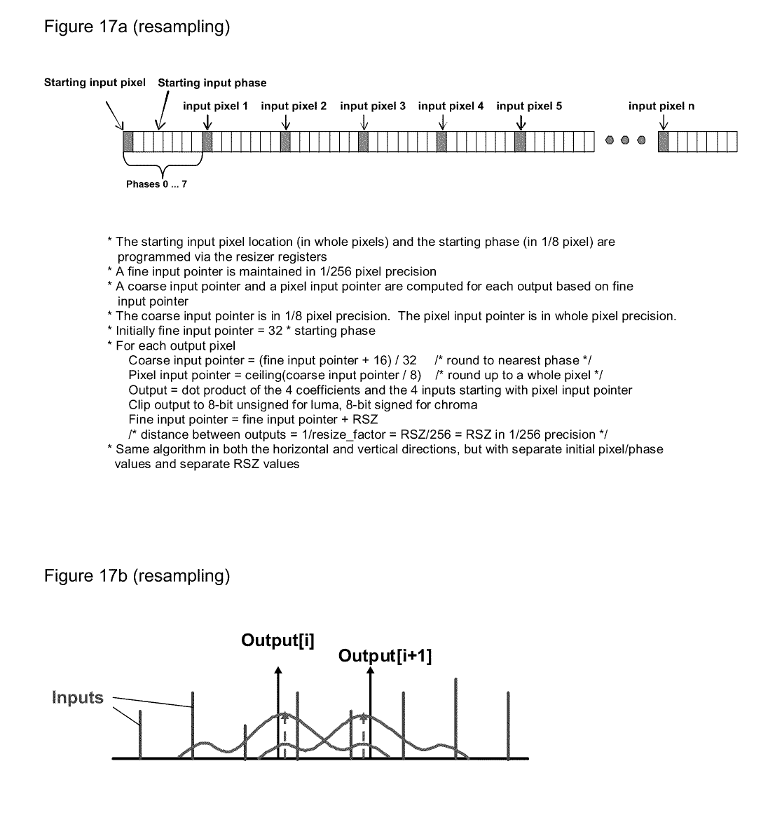

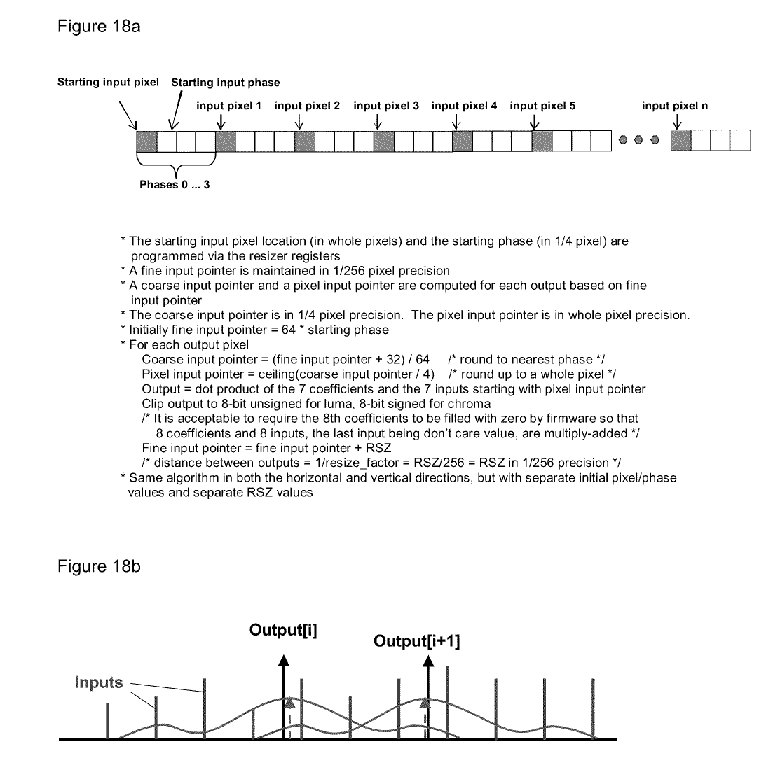

FIGS. 17a-17b show the resizer method in the 4-tap/8-phase mode. FIGS. 18a-18b show the 7-tap/4-phase method.

Standard implementation of resampling requires number of phase being the numerator of the resampling factor, in this case, 256. The resizer module is archtiected with approximation scheme to reduce the number of phases to 4 or 8, to reduce coefficient storage by a factor of up to 64. This approach reduces hardware cost while providing fine grain resampling factor control (compared with providing just 4/D resampling), and there should be minimal quality impact on the resized images.

Chroma inputs, Cb and Cr, are 8-bit unsigned that represents a 128-biased 8-bit signed number. Before resizing computation, chroma should have the 128 bias subtracted to convert back to 8-bit signed format (strictly speaking the signed chroma is called U and V instead of Cb and Cr). In resizing, chroma should be processed as 8-bit signed number. After vertical resizing, the 128 bias should be added back to convert back to 8-bit unsigned format.

Edge enhancement can be optionally applied to the horizontally resized luminance component before the output of the horizontal stage is sent to the line memories and the vertical stage. Either a 3-tap or a 5-tap horizontal high-pass filter can be selected to use in the luminance enhancement as shown below. If the edge enhancement is selected, the two left most and two right most pixels in each line will not be output to the line memories and the vertical stage. The edge enhancement algorithm is as follows.

```
HPF(Y) = Y convolved with
        { [−0.5, 1, −0.5] or [−0.25, −0.5, 1.5, −0.5, −0.25] }
hpgain = max (GAIN, ( |HPF(Y)| − CORE ) * SLOP)
        Y = Y + (HPF(Y) * hpgain + 8) >> 4
```

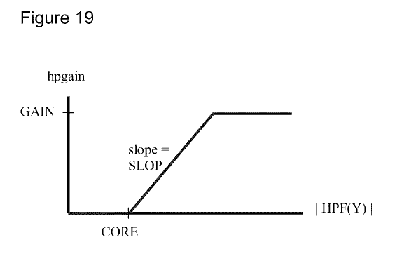

Basically, the high pass gain is computed by mapping the absolute value of high passed luma with the curve of FIG. 19.

CORE is in U8Q0, or unsigned 8-bit integer format. SLOP is in U4Q4, or unsigned 4-bit fraction format. GAIN is in U4Q4, or unsigned 4-bit fraction format. Hpgain is computed with sign/integer bits plus 4-bit of fraction, but can be saturated to 0.15 (representing 0.15/16) before clipping by GAIN.

The selectable high-pass filter kernel allows different degree of sharpening. The 3-tap filter offers general-purpose sharpening, while the 5-tap filter has a frequency characteristic to amplify a wider spectrum of the input image. The 5-tap filter works well with large downsampling factor (from 2 to 4), where a larger portion of the spectrum is attenuated due to the resampling filter.

The resizer should support multiple passes of processing for larger resizing operations. By “larger” there are several meanings:
Wider output than 1280 pixels. This only works in SDRAM input mode. Input can be partitioned into multiple resizer blocks, and each block is separately resized, and put together. Having input/output SDRAM line offsets, input starting pixel and starting phase are essential to make this work.
Larger than 4× upsampling problem. Resizing can be applied in multiple passes. For example, 10× upsampling can be realized by first a 4× upsampling, then a 2.5× upsampling. The first pass can be performed on-the-fly with preview. The second pass can only be performed with input from SDRAM, and for 10× digital zoom, there is time outside the active picture region to perform the second pass.
Larger than 4:1 downsampling. Although it is rare that we need to generate a very small image from a big image, it is supported by the hardware. For example, 10× downsampling can be realized first with 4× downsampling on-the-fly the preview, then 2.5× downsampling in SDRAM-input path. There may not be much time outside the active data region for the second pass, but since it's already reduced to 1/16 of original size, we do not need a lot of time. Typically CCD sensor or video input has 10˜20% of vertical blanking that we can use.
   Computation time for 10× zoom is shown as an example.
Assume 1280×960×30 frames/sec input. A 320 wide×240 tall window of the input is resized back to 1280×960.
10× zoom is implemented as on-the-fly 4× upsampling with output written to SDRAM, then as 2.5× SDRAM-input resizing.
As the active region of input is only ¼ of height and ¼ width of a 30 frames/sec input frame, module spends ¼* 1/30=8.33 msec to complete the first pass. This is not taking into account of the horizontal/vertical blanking (if we do the first pass will take less).
The second pass's horizontal stage takes, 1280*(960/2.5)*4 multiplies/color*2 colors/pixel/(150 MHz*4 multiplies)=6.55 msec, assuming vertical stage keeps up.
The second pass's vertical stage takes, 1280*960*4 multiplies/color*2 colors/pixel/(150 MHz*16 multiplies)=4.10 msec, assuming horizontal stage keeps up
The second pass actually takes 6.55 msec, bottlenecked at the horizontal stage. (Vertical stage can deal with 4× upsampling from horizontal stage output, so unless resizing factor is exactly 4, horizontal stage is always the bottleneck.)
Total time for both passes=14.88 msec, meeting the 30 frames/sec=33.3 msec time budget.
   The above calculation shows that the worst-case total time is when the second pass only needs to upsize a little bit, say 1.01. With the same input size/rate assumption, this 4.04× resizing takes
¼* 1/30=8.33 msec on the first pass
1280*(960/1.01)*4*2/(150M*4)=16.33 msec on the second pass. Total time for both passes=24.66 msec still meets the 30 frames/sec computation rate with about 26% of margin.
   The ability to specify starting pixel and starting phase allows the resizer module to be used to process a large picture, one block at a time. This greatly extends the capability of the resizer without increasing the size of the line buffer memory. Programmable resizer filter coefficients, separately for horizontal and vertical, offers flexibility in combining some other filtering operation in the resizing for free. For example, even if there is no resizing (resampling factor=256/256=1), the resizer module can be used for general-purpose filter (after Preview Engine or taking image form SDRAM).

### 6. H3A Module

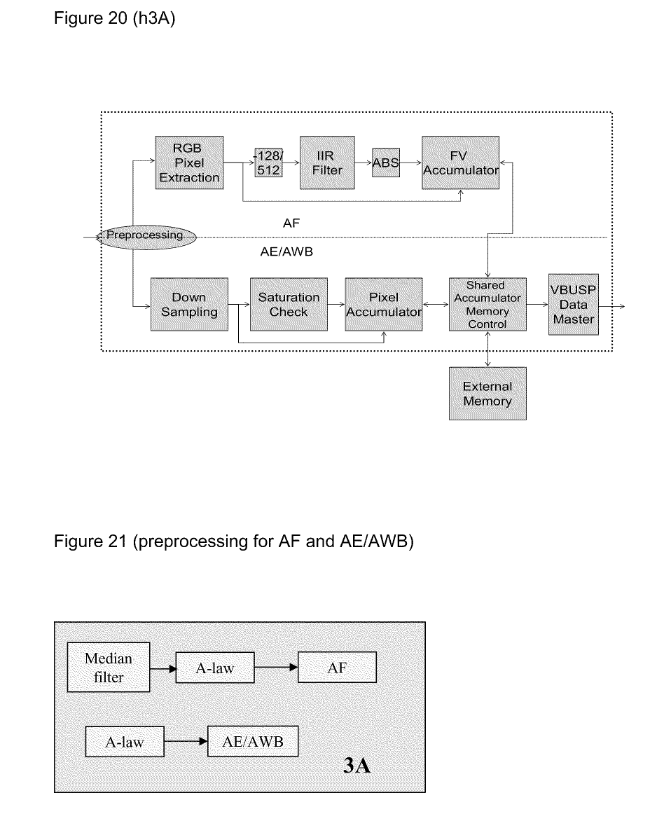

As shown in the high level block diagram in FIG. 20, the h3A module has two data paths through the design and a single data interface out of the module. After the preprocessing step, the data passes through 2 separate engines one for Auto Focus and one for Auto Exposure and Auto White Balance.

Prior to directing the image/video data to the AF and AE/AWB data paths, the h3A module has the task of preprocessing the input data. The preprocessing steps that are necessary are a horizontal median filtering step and a 10-bit to 8-bit A-law compression step. FIG. 21 shows the preprocessing done for the AF and AE/AWB blocks. The median filter and the A-law can be enabled/disable via register settings.

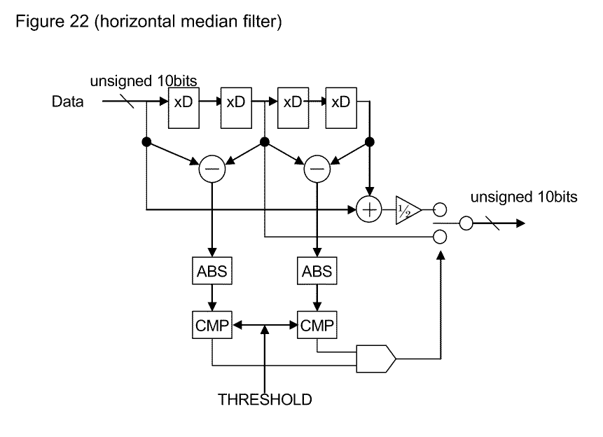

The horizontal median filter, shown in FIG. 22, calculates the absolute difference between the current pixel (i) and pixel (i−2) and between the current pixel (i) and pixel (i+2). If the absolute difference exceeds a threshold, and the sign of the differences is the same, then the average of pixel (i−2) and pixel (i+2) replaces pixel (i). The horizontal median filter's threshold is configurable and the horizontal median filter can either be enabled or disabled.

The A-law conversion routine compresses the 10-bit value to an 8-bit value. In the case of the A-law table being enabled, the output is still 10-bits with the upper two bits filled with a 0.

The Auto Focus Engine works by extracting each red, green, and blue pixel from the video stream and subtracts a fixed offset of 128 or 512 (depending of whether the A-law is enabled or disabled) from the pixel value. The offset value is then passed through an IIR filter and the absolute value of the filter output is the focus value or FV. The Focus values can either be accumulated or the maximum FV for each line can be accumulated. The maximum FV of each line in a Paxel is acquired if FV mode is set to ‘Peak mode’. Values of the red, green, and blue pixels and either the accumulated FV or the maximum FV are accumulated in the Paxel, and are sent out the data interface.

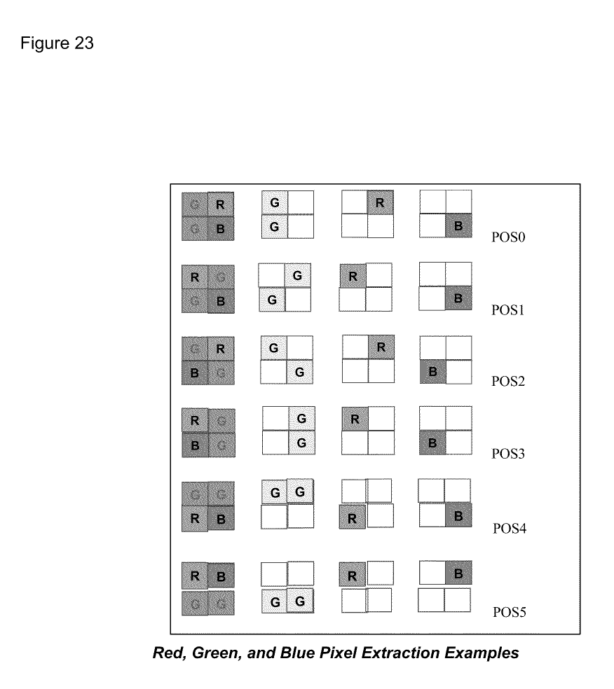

The Red, Green, and Blue Pixel extraction is controlled by a register setting that specifies which of the six possible modes is to be used as shown in FIG. 23. The red and blue pixel positions are interchangeable.

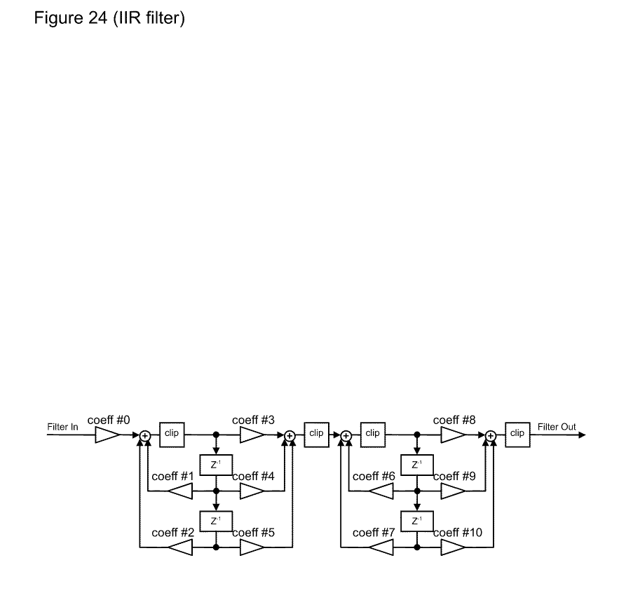

The focus value calculator takes the unsigned red/green/blue extracted data and subtracts 128 or 512 (depending on whether the A-law is enabled or disabled) to place the data in the range −128 or 512 to 127 or 511. After the removing the offset, the data is sent through two IIR filters each with a unique set of 11 Coefficients; see FIG. 24. Each coefficient is 12-bits wide with 6-bits of decimal (S12Q6). The filter shift registers are cleared on each horizontal line at the position set by the register IIR horizontal start register. The absolute value of the output (16-bits wide with 4-bits of decimal, U16Q4) is then sent to the accumulator module.

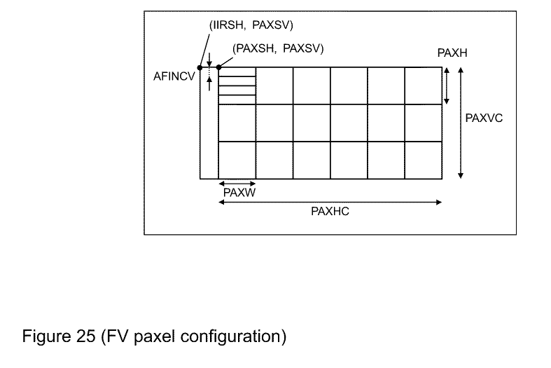

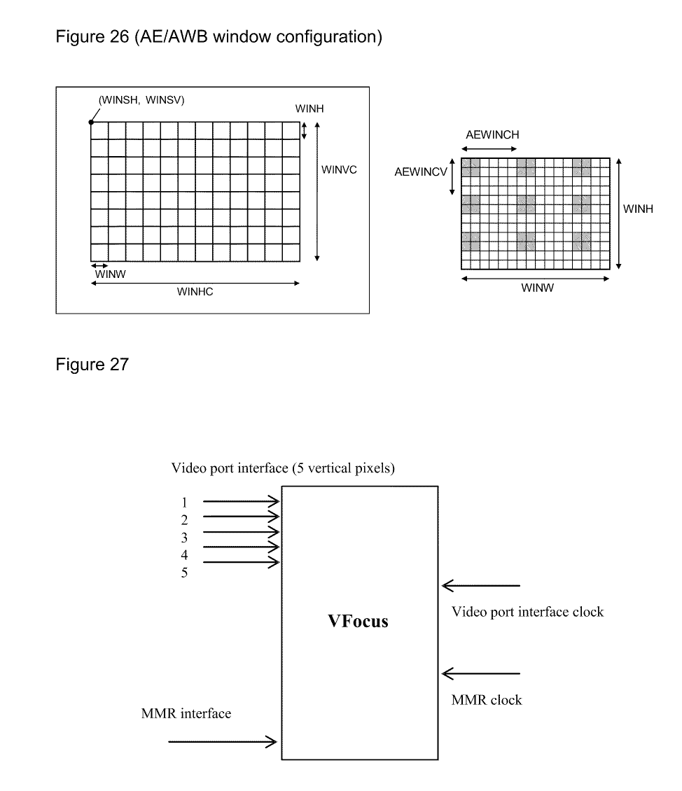

The FV Accumulator takes the FV values from the filter and accumulates the FV values for each Paxel. The size and number of Paxels is configurable by registers. In the Peak Mode, maximum value is accumulated. In the Sum mode, all FV are accumulated in a Paxel; see FIG. 25.

The AE/AWB Engine starts by sub-sampling the frames into windows and further sub-sampling each window into 2×2 blocks. Then for each of the sub-sampled 2×2 blocks the each pixel is accumulated. Also, each pixel is compared to a limit set in a register. If any of the pixels in the 2×2 block are greater than or equal to the limit then the block is not counted in the unsaturated block counter. All pixels greater then the limit are replaced by the limit and the value of the pixel is accumulated.

The Sub-Sampler module takes setting from the register for the starting position of the windows is set by WINSH for the horizontal start and WINSV for the vertical start. The width of the window is set by WINW and the height by WINK The number of windows in a horizontal direction is set by WINHC while WINVC set the number of windows in the vertical dimension.

Each window is further sampled down to a set of 2×2 blocks. The horizontal distance between the start of blocks is set by AEWINCH. The vertical distance between the start of blocks is set by AEWINCV.

The saturation check module takes the data from the sub-sampler and compares it to the value in the Limit Register. It replaces the value of a pixel that is greater then the value in the limit register is replaced with the value in the limit register. If all 4 pixels in the 2×2 block are below the limit then the value of the unsaturated block counter is incremented. There is 1 unsaturated block counter per window.

The data output from the saturation check module and the sub-sampler module are each accumulated for each pixel. There are a total of 8 accumulators per window.

In addition to the 128 vertical paxels/windows, the AE/AWB module provides support for an additional vertical row of paxels/windows for black data. The black row of paxels/windows can either be before or after the 128 regular vertical paxels/windows. The vertical start setting for the black row of paxels is specified by a separate register setting. Furthermore, the height of the black row of paxels is specified separately from the regular vertical rows of paxels/windows.

The VBUSP DMA Interface module is responsible for taking the data from the AF Engine and the AE/AWB Engine and building packets to be sent out to the SDRAM/DDRAM. The data interface has separate start and end pointers for the both the AF and AE/AWB engine. It will continuously loop through this data as it builds the packets.

### 7. Vertical Focus Module

FIG. 27 shows the high level block diagram of the VFocus module. The VFocus module accepts noise filtered raw image/video data from the preview engine (via the video port interface) and computes the focus metrics. The registers are accessed (for both read and write) via the MMR interface.

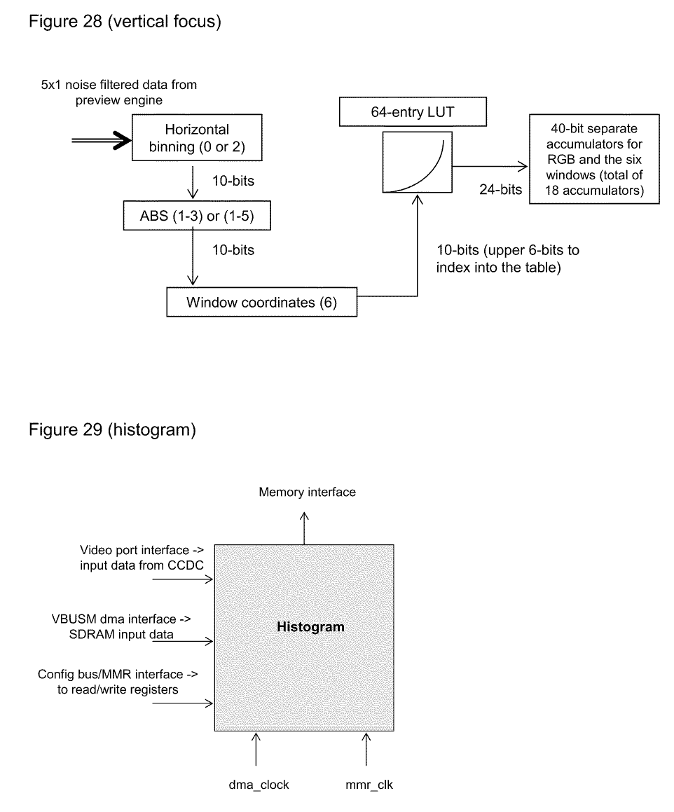

FIG. 28 shows the functional block diagram of the VFocus module. The algorithmic steps are:
Perform horizontal binning (averaging) of two consecutive pixels of the same color in the horizontal direction. For example, if the total number of input pixels is 1280, applying horizontal binning will lead to an output of 640 pixels. This step can be optionally disabled.
Compute the absolute difference of either the pixels on line 1 and line 3 or line 1 and line 5 (selectable).
Feed the upper 6 bits of the 10-bit output from the previous step into a 64-entry piece-wise linear interpolated table to get a 16-bit output.
   A linear interpolation is then performed according to the equation below

$$y = \frac{( {LUT}_{i} - {LUT}_{i - 1} ) * ( x \& 0 xF )}{16} + {LUT}_{i - 1}$$

Where y is the output response, x is the output of the windowing, and LUTᵢ is the element in the lookup table at address i, where i=((x>>4) & 0x3F). LUT₋₁ is assumed to be an entry of 0.
The number of bits of y is 24
Accumulate y in the corresponding color and window accumulator (40-bit wide).
While reading/writing the registers, the VFocus block must be disabled.

### 8. Histogram

The histogram module accepts raw image/video data from the CCDC, performs a color-separate gain on each pixel (white/channel balance), and bins them according to the amplitude, color, and region which are all specified via its register settings. It can support either 3 or 4 colors, and up to 4 regions simultaneously. FIG. 29 shows the high-level block diagram of the histogram module.

Histogram function supports the following
Up to 4 regions (areas)
   Each region has separate on/off control
   Each region has its own start coordinate X/Y (12-bit) and horizontal/vertical sizes (12-bit)
   When the regions overlap, only one region is operated on (selected bin incremented)
CFA data assumed (interleaved RGr lines and GbB lines); although other preferred embodiments could accept Foveon sensor data. Data for each color goes into a separate set of bins
Bins are counters, counting number of values being in the range associated with the bins
Per color, per region, there can be 32, 64, 128, or 256 bins
Data values are first down-shifted then saturated for bin selection 1024×20-bit memory used
   The user is responsible for resetting the histogram RAM. This can be done two ways.
(a) Writing zeros to the RAM via software
(b) If the CLR bit is set reading the memory will cause it to be reset after the read.
   CPU reads and writes shall be blocked when the Start/Busy bit is 1.

The histogram RAM is 1024×20-bit in size. Therefore the user can attempt to select conditions that require more memory (example 4 active regions and 128 bins per color). The manual shall call these out as illegal conditions but the hardware shall not fail if the user uses these illegal settings. The hardware shall limit the number of bins in the following way:

| Regions | Bins allowed |
|---|---|
| 1 | 256, 128, 64, 32 |
| 1, 2 | 128, 64, 32 |
| 1, 2, 3 | 64, 32 |
| 1, 2, 3, 4 | 64, 32 |

The histogram RAM is 20 bits wide. If incrementing a histogram bin would cause the value to become greater than what the RAM word could hold the value shall be saturated to the maximum value RAM word will hold, which is 2̂20−1.

The input data width is 10 bits wide (9 . . . 0) and the data to be histogrammed is 8 bits wide. Therefore if the input value is larger than the highest bin location the result shall be clipped to the highest bin location. This allows data from above the bin range to be included in the upper most bin.

### Example

1 Region enabled
256 bins per color
Shift=0
Pixel value=1000
Pixel value (1000)>Max bin index (255)
   Therefore the down-shifted pixel value is clipped to max bin index, 255, and bin 255 is incremented. If bin 255 already holds a value of 2̂20−1, this incrementing is saturated so that 2̂20−1 remains in the bin.

Starting address of the regions in various number of bins configuration is shown in the next table:

| | Region 0 | Region 1 | Region 2 | Region 3 |
|---|---|---|---|---|
| 256 bins | 0 | | | |
| 128 bins | 0 | 512 | | |
| 64 bins | 0 | 256 | 512 | 768 |
| 32 bins | 0 | 128 | 256 | 384 |

Offset of colors within each region in the RAM is shown in the next table:

| Color | Lines | Pixels | Offset |
|---|---|---|---|
| Color 0 | even | even | 0 |
| Color 1 | even | odd | 0 + 1 * Number of Bins |
| Color 2 | odd | even | 0 + 2 * Number of Bins |
| Color 3 | odd | odd | 0 + 3 * Number of Bins |

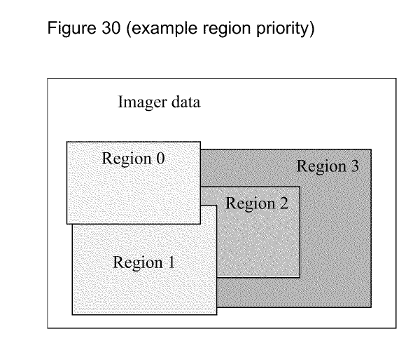

FIG. 30 shows the priority and an example organization of the four image regions for the histogram. The priority of the regions is: region0>region1>region2>region3.

### 9. Modifications

The preferred embodiments can be modified in various ways while retaining one or more of the features of video processing front-end modules connected for data transfers under autonomous operations.

For example, the vertical auto focus and the horizontal auto focus could be put into a common processing module (either part of h3A or a separate module); the various parameters such as bus widths, filter coefficients, et cetera could be varied; processing modules for additional image pipeline functions could be added, such as the white balance, lens shading compensation, lens distortion compensation, adaptive fault pixel correction (the hardware does not require a calibrated/capture fault list), and video stabilization.

What is claimed is:

1. A method for a digital signal processor for processing data relating to a video, comprising:
receiving the data;
determining, in the digital signal processor, if the data includes at least one of an end of line or an end of frame;
if there is not sufficient data for an optimal data transfer, buffer the data and wait for at least one of more data, end of line or end of frame;
if there is sufficient data for an optimal transfer, transfer the data to external memory.

2. The method of claim 6 further comprising prioritizing the devices and transferring the data according to the priority.

3. The method of claim 6 further comprising determining optimal amount data for promoting efficient transfer.

4. The method of claim 6 further comprising determining requisite external memory required for the transfer.
